(19) United States
(12) Patent Application Publication
(10) Pub. No.: US 2026/0309869 A1
(43) Pub. Date: Oct. 8, 2026

(54) AIRBORNE HIGH-PRECISION IMAGING SYSTEM AND METHOD FOR SINGLE-PHOTON UNMANNED AERIAL VEHICLES

(71) Applicant: Anhui University, Hefei (CN)

(72) Inventors: Youwen SUN, Hefei (CN); Haobing ZHAO, Hefei (CN); Xin HE, Hefei (CN); Yanrui XU, Hefei (CN); Zhenda SUN, Hefei (CN); Mingxu SHI, Hefei (CN); Xiaomin HU, Hefei (CN); Biheng LIU, Hefei (CN)

(21) Appl. No.: 19/684,429

(22) Filed: May 21, 2026

(30) Foreign Application Priority Data
Oct. 28, 2025 (CN) 202511544015.9

(51) Int. Cl. G01S 17/89; G01S 7/481; G01S 7/4861; G01S 7/4865; G01S 17/10; H04N 23/56; H04N 23/68

(52) U.S. Cl. CPC G01S 17/89; G01S 7/4812; G01S 7/4817; G01S 7/4861; G01S 7/4865; G01S 17/10; H04N 23/56; H04N 23/6812; H04N 23/683

(57) ABSTRACT

The present disclosure provides an airborne high-precision imaging system and method for single-photon unmanned aerial vehicles, which involves the field of airborne imaging system, including a real-time attitude-aware jitter acquisition unit, a high-speed transceiver control signal acquisition and transmission unit, a spatial scanning two-dimensional scanning unit, a real-time data processing motion compensation unit, and a main control unit that coordinates global timing control. The signal acquisition unit adopts a transceiver-integrated coaxial optical structure and introduces a dynamic light leakage suppression mechanism. The jitter acquisition unit integrates the high-frequency inertial measurement unit IMU, and the sampling frequency is higher than the laser pulse frequency through the compensation algorithm, and the three-axis attitude and yaw angle data of the body in the dynamic environment are collected in real time with high time resolution.

### TECHNICAL FIELD

The present disclosure relates to the field of airborne imaging systems. Specifically, it relates to an airborne high-precision imaging system and method for single-photon unmanned aerial vehicles.

### BACKGROUND

Three-dimensional imaging technology holds significant value in the fields of environmental perception, autonomous driving, surveying and mapping, and intelligent inspection. Light Detection and Ranging (LiDAR) has become a core means of acquiring three-dimensional point clouds owing to its high resolution and high-precision ranging capabilities. However, when LiDAR is mounted on highly dynamic platforms such as unmanned aerial vehicles (UAVs), the performance of the system is severely constrained.

During flight, a UAV is subject to disturbances from rotor vibration, gusts, and airflow turbulence, which induce high-frequency and unpredictable variations in its attitude (pitch angle, roll angle, yaw angle). As each laser pulse is transmitted and received, the attitude of the aircraft differs, resulting in “distortion” and “deformation” of the point cloud. This impairs the accuracy of three-dimensional reconstruction and seriously compromises the execution of tasks requiring high-precision mapping and navigation.

Among existing technologies, some solutions employ high-frequency LiDAR or SLAM-based post-processing registration methods; however, their high cost, computational complexity, or substantial latency render them incapable of meeting real-time requirements. Another approach relies on LiDAR odometry or inertial navigation systems to provide the poses at the beginning and end of each frame, followed by interpolation compensation based on a constant-velocity assumption. Nevertheless, these methods cannot effectively address the high-frequency vibrations characteristic of UAV platforms.

In addition, single-photon imaging also faces the challenge of a low signal-to-noise ratio, particularly under the influence of daytime background noise and device dark counts. Existing suppression techniques, such as narrowband filtering or increasing laser power, are constrained by the limited payload and power budget of UAVs.

In summary, the primary challenges currently confronting UAV-borne single-photon imaging radar are: motion distortion, insufficient sensor synchronization accuracy, and a low signal-to-noise ratio. These issues undermine the system's ability to achieve high-precision measurements and maintain real-time performance; therefore, it is imperative to develop an effective technical solution to address the aforementioned problems.

### SUMMARY

The purpose of this present disclosure is to solve the problem of imaging motion distortion caused by severe vibration of UAV platforms and airflow turbulence, and the technical problem of insufficient signal-to-noise ratio of single-photon detection caused by light leakage and near-field backscattering in the optical system, and to provide an airborne high-precision imaging system and method for single-photon unmanned aerial vehicles.

To achieve the above purposes, the technical solution provided by the present disclosure is as follows:

An airborne high-precision imaging system for single-photon unmanned aerial vehicles, including: a main control unit, a jitter acquisition unit, a signal acquisition and transmission unit, a two-dimensional scanning unit, and a motion compensation unit;
where the main control unit is electrically connected with the jitter acquisition unit, the signal acquisition and transmission unit, the two-dimensional scanning unit, and the motion compensation unit, respectively, configured to provide a picosecond global timing synchronization signal;
the jitter acquisition unit is connected with the motion compensation unit in a manner of communication, configured to transmit IMU data of the inertial navigation unit to the motion compensation unit in real time;
the signal acquisition and transmission unit is connected with the two-dimensional scanning unit in a manner of an optical path, configured to emit a laser pulse to a target area through the two-dimensional scanning unit;
the signal acquisition and transmission unit is connected with the motion compensation unit in a manner of data, configured to transmit a timestamp of a photon event to the motion compensation unit;
the motion compensation unit is configured to align the IMU data of the inertial navigation unit with the timestamp of a photon event, calculate an instantaneous attitude of each photon event, and perform a point-by-point correction on a spatial position of a photon event to eliminate a point cloud motion distortion.

In some embodiments, the signal acquisition and transmission unit adopts a transceiver-integrated coaxial optical structure, and a dynamic light leakage suppression mechanism is set; the dynamic light leakage suppression mechanism includes a time-to-digital converter (TDC) to accurately measure a timestamp of each laser pulse transmission and echo photon reception, and a nanosecond-level gating control of two acousto-optic modulators (AOMs) by the main control unit to physically cut off a receiving optical path before an echo photon arrives to suppress light leakage and near-field scattered light in a system.

In some embodiments, the two-dimensional scanning unit may adopt a MEMS micromirror, whose function is to scan a laser pulse beam in space at high speed to cover the target area and generate point cloud data.

In some embodiments, the motion compensation unit adopts a single-photon event-level jitter compensation algorithm, which adopts an IMU-based pre-integration sensor fusion algorithm instead of a traditional linear interpolation method. The algorithm pre-integrates the inertial data of the IMU, and accurately calculates the motion and attitude increment of the system between the two IMU measurement moments, the IMU data and the laser data are aligned in the time domain, and the attitude at each photon event moment can be obtained. The three-axis attitude (pitch angle, roll angle, and yaw angle) data of the UAV in the dynamic environment are collected in real time with high time resolution, thus solving the problem of data sparsity caused by the IMU data sampling frequency lower than the LiDAR pulse frequency. Subsequently, the algorithm takes the pre-integrated IMU data and the echo data of each laser pulse as factors, and optimizes them through the joint optimization of pixel geometric constraints and motion compensation constraints. Therefore, the algorithm can accurately calculate the instantaneous attitude of each transmitting and receiving photon event.

In some embodiments, the nanosecond timestamp of a photon event is accurately calculated. The three-axis attitude information corresponding to the timestamps of the transmitted and receiving photon events is extracted.

In some embodiments, the unique jitter compensation algorithm is configured to calibrate the time-of-flight (TOF) and spatial position of the photon with high precision, and the position information of each photon event is accurately corrected to an earth coordinate system. This point-by-point correction, instead of traditional linear interpolation, fundamentally eliminates the point cloud distortion caused by nonlinear motion, and improves the point cloud accuracy from centimeter level to micron level.

An airborne high-precision imaging method for single-photon unmanned aerial vehicles, including the following steps:
Step 1: using a FPGA synchronization signal of the main control unit as the global clock to synchronize the pulse laser, the time-to-digital converter TDC, a two-dimensional galvanometer, and a high-frequency IMU;
Step 2: triggering the pulse laser to emit ultrashort pulses and starting a TDC timing by the main control unit to record a timestamp of a transmitting photon event;
Step 3: closing the receiving optical path with nanosecond gating within a predetermined dead time by the main control unit, and opening the receiving optical path within a time window of an expected echo photon arrival to achieve dynamic light leakage suppression;
Step 4: gating echo photons into a single-photon detector SPAD to trigger TDC to stop timing and recording a timestamp of a receiving photon event;
Step 5: collecting attitude data and aligning it with the photon transmission/reception timestamp by the high-frequency IMU, combined with a system-calibrated transmitting optical path and a receiving optical path delay, obtaining a three-axis instantaneous attitude corresponding to each photon event;
Step 6: using a single-photon event-level jitter compensation algorithm to calibrate a flight time and a spatial position of each photon event with high precision and eliminate a point cloud motion distortion.
Step 7: performing a denoising and sparse point cloud reconstruction on the point cloud compensated by motion, and outputting a stable and clear 3D scene.

Compared with the existing technology, the beneficial effects of the present disclosure are as follows:
1, the present disclosure employs a “single-photon event-level” high-precision motion compensation scheme supported by high-frequency IMU data, thereby fundamentally overcoming the limitation of traditional methods in effectively addressing point cloud distortion caused by the nonlinearity and high-frequency jitter inherent to UAV platforms. This advancement elevates the accuracy of distortion correction from the centimeter level typical of conventional approaches to the millimeter level, enabling the acquisition of more stable and sharply defined three-dimensional scene data.
2, through the dynamic time-gating mechanism implemented by the TDC and AOM, the present disclosure effectively blocks the influence of near-field intense light and annular fiber-optic leakage on the single-photon detector. It resolves the issues of detector saturation and dead time, thereby substantially enhancing the signal-to-noise ratio and the detection robustness of the system.
3, the combination of a high signal-to-noise ratio and elevated sensitivity empowers the system to effectively detect weak photon echoes originating from extended distances, consequently expanding both the effective detection range and the operational scope of single-photon radar.
4, the integration of hardware-level high-precision timing synchronization with multi-sensor fusion algorithms enables the system to maintain robust high-precision perception and reconstruction capabilities even under the most demanding dynamic environments. This provides powerful technical support for UAV applications in high-precision three-dimensional mapping, intelligent inspection, and autonomous navigation.

### BRIEF DESCRIPTION OF THE DRAWINGS

FIG. 1 is a schematic diagram of the overall architecture of the UAV-borne single-photon imaging radar system.

FIG. 2 is a timing diagram of the dynamic light leakage suppression mechanism of the present disclosure;

FIG. 3 is a schematic diagram of the registration and transformation relationship of the multi-sensor coordinate system of the present disclosure;

FIG. 4 is a flow chart of the single-photon event-level jitter compensation algorithm of the present disclosure.

### DETAILED DESCRIPTION

In order to make the purpose, technical solutions, and advantages of the present disclosure more clearly understood, the present disclosure is described in further detail below in conjunction with the accompanying drawings and exemplary embodiments. It should be understood that the specific embodiments described herein are provided solely for the purpose of illustrating the present disclosure and are not intended to limit the scope of the present disclosure. Furthermore, the technical features disclosed in the various embodiments of the present disclosure described below may be combined with one another in any manner, provided that no mutual conflict arises from such combination. To achieve the foregoing objectives, the present disclosure adopts the following technical solutions.

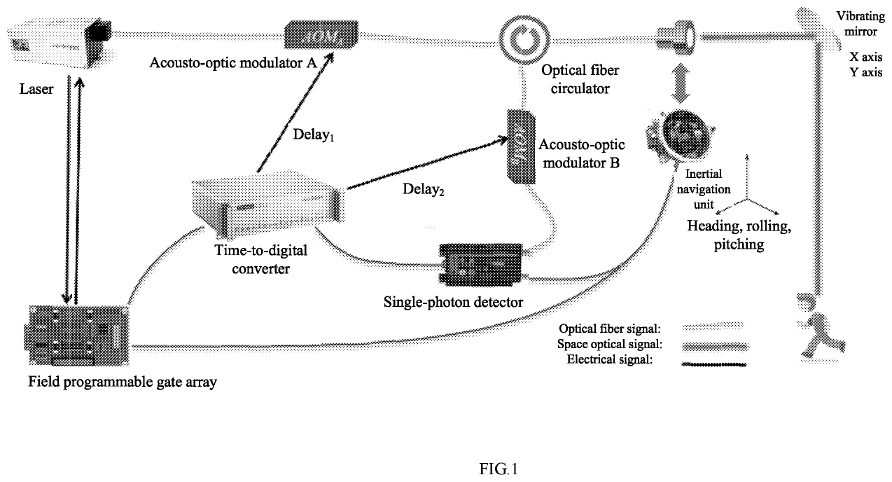

The present disclosure provides an airborne high-precision imaging system for single-photon unmanned aerial vehicles, as shown in FIG. 1, including a laser, an acousto-optic modulator A (AOM_A), an acousto-optic modulator B (AOM_B), a fiber circulator, a single-photon detector SPAD, a time-to-digital converter TDC, a main control module FPGA, an inertial navigation unit IMU, and a two-dimensional scanning galvanometer MEMS.

The connection relationship and function of each component are as follows: the output light of the laser is coupled into the input end of the fiber circulator through AOM_A modulation, and the laser pulse is guided to the two-dimensional scanning galvanometer MEMS through the fiber circulator; the two-dimensional scanning galvanometer MEMS swings at a high speed along the horizontal X-axis and the vertical Y-axis to achieve two-dimensional beam scanning of the target area; after the laser pulse irradiates the target, the reflected optical signal returns along the original path, and is coupled into the fiber circulator through the two-dimensional scanning galvanometer MEMS, and the echo signal is guided to AOM_B by the fiber circulator. After AOM_B gates the returned optical path, the signal is transmitted to the single-photon detector. Single-photon detectors, such as avalanche photodiodes (SPADs) working in Geiger mode, output the corresponding electrical signal pulse when a single-photon event is detected. The pulse signal is input into the time-to-digital converter (TDC), and the TDC accurately records the timestamp or time-of-flight (TOF) data of photon arrival. The FPGA is electrically connected to the above components and provides real-time control and data acquisition: the FPGA sends a synchronous trigger signal to the laser to emit a laser pulse, sends a gating control signal to AOM_A and AOM_B to turn on/off the optical path in time sequence, and obtains the time-of-flight measurement value of the photon from the TDC. Meanwhile, the FPGA is also connected to the high-frequency IMU. The FPGA provides a synchronous clock with a picosecond absolute time reference. The IMU outputs the attitude angular velocity and acceleration data of the UAV platform at a high sampling rate of 2 kHZ, and provides real-time attitude after processor fusion processing. Through the above structure, each module cooperates to realize single-photon laser ranging and attitude synchronous acquisition, which provides basic data for subsequent motion compensation and point cloud reconstruction.

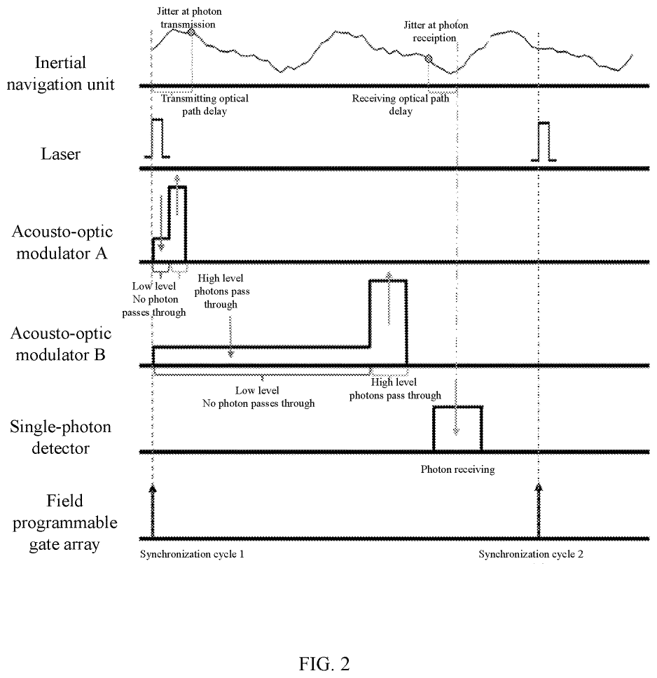

As shown in FIG. 2, aiming at the problem of low signal-to-noise ratio caused by internal light leakage and environmental noise of LiDAR during high-speed flight, the dynamic light leakage suppression mechanism of double AOM gating is designed. As shown in FIG. 2, the FPGA generates two synchronous gating signals to control AOM_A and AOM_B, respectively, and divides the transmitting window and receiving window in each laser transmission cycle.

Specifically, in the initial stage of each laser ranging cycle, the FPGA first outputs a synchronous pulse signal to trigger the laser to emit a 1.5 ns narrow pulse laser. At almost the same time, the FPGA sends an open signal to the AOM_A to switch the AOM_A to a high transmission state to allow the laser pulse to pass through and enter the transmitting optical path; after a pulse-width-length laser pulse passes smoothly, the FPGA quickly turns off the AOM_A to a low-transmittance (high-loss) state, thereby blocking the laser's subsequent possible leakage or stray light into the optical path. During the transmitting window, AOM_B remains closed (low transmission state) to prevent the transmitting pulse from being directly coupled to the receiving end through the fiber circulator to cause saturation interference. Subsequently, in the receiving stage of the period, the FPGA sends a control signal to turn on AOM_B according to the preset delay window, that is, only in the time window of the expected target echo arrival, the AOM_B is in a high transmission state, allowing the echo photons to pass through and enter the SPAD detector. Once the receiving window ends, AOM_B is quickly turned off again to restore the light-blocking state.

Through the above dual AOM gating control, the laser transmission channel and the receiving channel are strictly separated in time: at the time of laser transmission, the receiving channel is closed to suppress direct light leakage; during the waiting for the echo, the transmission channel is closed to avoid continuous luminescence interference, which significantly reduces the possibility of crosstalk within the system and environmental stray light entering the detector. The open and close timing of AOM_A and AOM_B is precisely controlled at the nanosecond level by the FPGA, so that the receiving window width only covers the extremely narrow period near the expected signal arrival time. For example, according to the approximate distance between the UAV and the target, the delay and width of the receiving window are adjusted in real time to ensure that the real signal photons fall during the detector opening and most of the noise photons are rejected due to asynchrony.

TDC cooperates with the logic of the FPGA to measure the time of each photon event entering the receiving window, when the photon is detected, the corresponding flight time is recorded, and the noise triggering in the non-window period is ignored. Thanks to the above dynamic light leakage suppression design, the system can still maintain a high signal-to-noise ratio single-photon detection capability in a strong sunlight background or an airborne complex optical reflection environment.

For example, the optical isolation of double AOMs makes the detector not affected by saturation within hundreds of nanoseconds after the pulse is emitted. Combined with narrowband filtering and time filtering, the noise counting rate can be reduced to the level of single-photon counting, which significantly improves the ranging accuracy and effective detection distance.

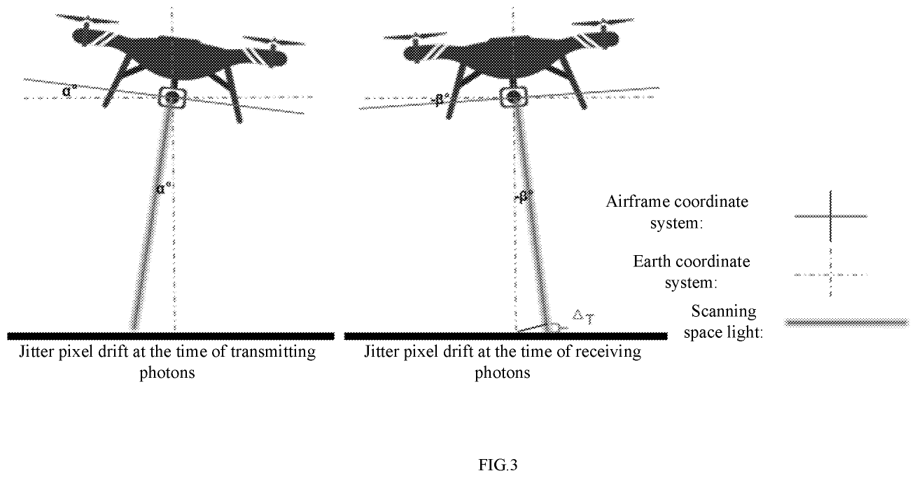

As shown in FIG. 3, the pixel drift of the transmitted photon and the received photon is jittered at the moment. When the UAV is hovering at high altitude, it will produce high-frequency jitter based on the body itself, that is, the body coordinate system will have a three-axis angle difference with the world coordinate system. However, the photon transceiver system is based on the body coordinate system, and the target object is based on the world coordinate system, which will lead to deviations in imaging pixels, intensity, and depth information.

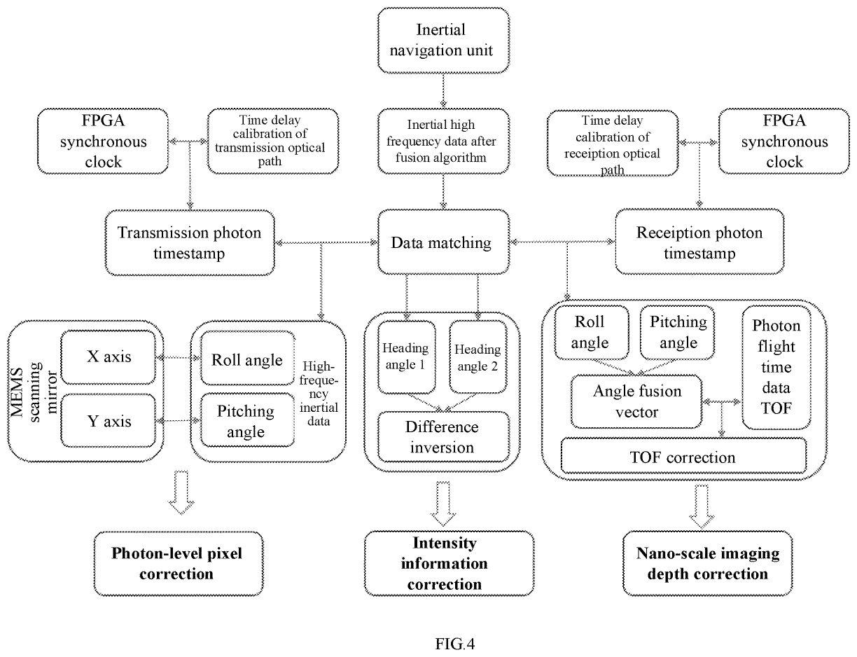

As shown in FIG. 4, it is a single-photon event-level jitter compensation algorithm of the present disclosure. Among them, the photon-level pixel correction includes: obtaining a priori delay information through the delay calibration of the transmitting optical path in advance, and performing clock synchronization with the reference clock of the FPGA to obtain the accurate timestamp of the photon emitted by the system transmitter; the high-frequency inertial navigation data is registered with the above timestamp to obtain the UAV attitude information corresponding to the emitted photon timestamp, specifically the roll angle and pitch angle; the above attitude information is registered with the offset angle information of the MEMS galvanometer in the X-axis Y-axis at this time, and the ejection angle corresponding to the photon timestamp in the world coordinate system can be obtained; from the above point of view, the position of the real pixel in the actual scanned image can be corrected.

The correction of the intensity information includes: the prior delay information is obtained by the delay calibration of the transmitting and receiving optical path in advance, and the clock synchronization is performed with the reference clock of the FPGA, and the accurate timestamp of the photon event at the transmitting and receiving ends of the system can be obtained; the high-frequency inertial navigation data is registered with the above timestamp to obtain the UAV attitude information corresponding to the timestamp of a photon event, specifically the heading angle at two photon moments. Due to the position difference (heading angle difference) between the transmitting and receiving times, the number of received photons will be reduced, and the larger the position difference, the fewer the number of received photons; that is, the difference of the flight angle is used to correct the number of photons.

The micron-level imaging depth correction includes: a priori delay information is obtained by receiving the optical path delay calibration in advance, and clock synchronization is performed with the reference clock of the FPGA to obtain an accurate timestamp of the photon event at the receiving end of the system; the high-frequency inertial navigation data is registered with the above timestamp to obtain the UAV attitude information corresponding to the timestamp of a photon event, specifically the roll angle and pitch angle. Meanwhile, the photon flight time data TOF is registered with the timestamp to obtain the TOF of the photon event, and the aircraft path information can be obtained. Because different angle information corresponds to different flight path information; the angle fusion vector can be obtained from the above roll angle and pitch angle, and the real TOF data of the photon event can be obtained by correcting the flight path information with the angle information.

Specifically, the FPGA or its connected processing unit performs pre-integration on the angular velocity and acceleration data output by the high-frequency IMU to calculate the relative attitude change of the UAV at the moment of each photon transmission and reception. For each laser pulse event, the timestamp provided by the TDC records the transmission time and the single-photon return time corresponding to the pulse. By pre-integrating the IMU data, the attitude data with the same frequency as the laser pulse can be obtained. Meanwhile, the transmitting optical path delay and the receiving optical path delay in the optical system can be obtained by calibration. The specific time of the two timestamps can be accurately calculated, and the attitude (heading, roll, pitch angle) and position of the UAV at the two timestamps can be obtained. Then, the attitude change of the UAV in this nanosecond flight time (as shown in FIG. 3, the body coordinate system changes slightly relative to the geographic coordinate system at the launch time and the receiving time) will lead to the offset and distortion of the uncorrected point cloud.

The present disclosure regards each photon ranging as a motion compensation unit: first, the attitude of the transmission moment is used to determine the direction of the laser pulse in the airborne coordinate system, and the initial space ray is determined by combining the deflection angle of the scanning galvanometer. Specifically, the roll angle of the body corresponds to the X axis of the MEMS galvanometer, and the pitch angle corresponds to the Y axis of the MEMS, and the photon event pixel correction is performed.

Then, the attitude of the receiving moment is used to determine the change of the UAV coordinate system relative to the geographic reference system. The relationship between the spatial point obtained by each photon ranging and the pose of the UAV is used as the observation factor. The received attitude transformation is transformed into an angle fusion vector, and the fusion angle is used for depth information calibration (one-dimensional depth information difference shown in FIG. 3), based on which micron-level imaging depth correction is performed.

Then, the pose of the UAV at each laser transmission/reception moment is taken as the state variable node; in the case that the received photon is regarded as returning along the original ray but the sensor attitude has changed, as the disparity in attitude angle increases, the loss of intensity information becomes increasingly significant; the differential inversion of the heading angle corresponding to the two timestamps is performed to correct the received reflected photon intensity information, thus forming a complete motion compensation optimization problem.

The coordinates of the reflection points corresponding to each photon event are accurately estimated in the global coordinate system, which greatly reduces the misalignment error caused by the high-speed attitude change of the airborne radar point cloud. Simply speaking, the method of this present disclosure is equivalent to ‘space-time correction’ for each laser point: the true projection angle and distance of the light in the geographic coordinate system are inverted based on the attitude difference between the transmitting and receiving time, so as to accurately restore the position of each photon event in the geographic coordinate system and realize the point-by-point distortion of the point cloud. The motion compensation is particularly effective in the case of severe maneuvering of the UAV, ensuring that the reconstructed 3D point cloud is consistent with the actual terrain and target.

Implementation process: The specific workflow of the system includes the following stages. The first is the system initialization and synchronization establishment: the FPGA main control and each sensor module are started, the AOM is reset to the initial closing state, and the laser enters the standby state; FPGA provides standard time pulses, synchronizes the system clock to the absolute time reference, and performs unified reference alignment on the data time axis of TDC and IMU. Then, the measurement cycle is entered: FPGA sends a trigger signal to the laser at a predetermined pulse repetition rate of 1 MHZ, and simultaneously generates a synchronous signal to send to TDC as the starting reference. The laser emits a laser pulse every time it receives a trigger, the laser pulse enters the fiber through the gating window of AOM_A and is emitted in a specific direction by the galvanometer. Then, the FPGA controls the AOM_A to turn off and waits for the preset delay to open the AOM_B receiving window. If the single-photon signal reflected by the target returns during this window period, it passes through AOM_B and is detected by SPAD. The electrical signal generated by SPAD is timed by TDC and the initial synchronization signal to obtain the TOF of the photon. The FPGA reads the TOF value recorded by the TDC and appends a time tag to the ranging event. Meanwhile, IMU outputs inertial data with high frequency in the whole process, and the FPGA receives and caches the IMU data stream in real time. Whenever a laser transmission and reception cycle is completed, the FPGA solves the attitude change amount of the IMU data in the corresponding period through the pre-integration algorithm, and obtains the transmitting and receiving attitude information of the ranging for subsequent distortion correction. The system continuously repeats the above pulse transmission and data acquisition process, and the galvanometer gradually changes the output angle according to the set scanning pattern, so that the laser beam covers the predetermined scanning line or field of view area in the target scene. During the whole operation process, FPGA coordinates the synchronization of each module: ensures that the laser trigger, AOM gating, IMU sampling, and TDC timing are strictly operated according to the unified time reference, and the typical synchronization accuracy is better than 1 nanosecond level, to ensure that the multi-sensor data fusion error is reduced to a negligible level.

In the data processing stage, the time difference conversion and the initial reconstruction of the point cloud are first performed: the corresponding distance is calculated according to the photon TOF measurement value, and the spatial coordinates are determined by combining the deflection angle and attitude of the secondary galvanometer. Then perform distortion correction and point cloud alignment: Based on the above factor graph optimization or extrapolation algorithm, the trajectory and attitude of the UAV are estimated smoothly based on the spatio-temporal information of all collected photon events, and the spatial position deviation of each point is corrected to align the point cloud in the geographic coordinate system. Then, point cloud filtering and denoising are performed. Due to the inherent probability of noise triggering and multi-photon aliasing in single-photon detection, the histogram accumulation method is used to identify the effective echo (if multiple photons are detected near the same position in one scan and the distance is consistent, it is judged as a real target) to eliminate abnormal outliers and non-real ranging points. Finally, the filtered three-dimensional point cloud data is reconstructed and output: according to the application requirements, the point cloud can be converted into a digital elevation model (DEM) or a three-dimensional grid, or directly superimposed into a map model in the mapping coordinate system; meanwhile, the pseudo-color rendering can be combined with the return intensity information of each pixel (obtained by multiple echo counts or photon counts statistics) to generate a more readable radar imaging map.

Key hardware structure and parameter setting examples: In this embodiment, each core hardware uses high-performance devices, and parameter optimization settings are performed according to single-photon detection requirements. The laser is preferably a pulsed fiber laser with a central wavelength of near-infrared 1550 nm, a single pulse energy of microfocus, a pulse width of about 1.5 ns, and a pulse repetition frequency of more than 1 MHz, to provide high detection sensitivity and sufficient point cloud density. AOM_A and AOM_B adopt a high-speed acousto-optic modulator, whose rising/falling edge response time does not exceed tens of nanoseconds, the on-state insertion loss is less than 3 dB, and the off-state has a high extinction ratio (>50 dB) to ensure that the gating window can be quickly opened and closed and effectively isolate the direct light. The time-to-digital converter TDC has a picosecond time resolution (such as a single-step resolution of about 10 picoseconds), corresponding to a range resolution of millimeters.

High-frequency IMU, such as the combination of three-axis gyroscope and accelerometer, has a sampling frequency of 2 kHz, a low angle random walk coefficient, and a dynamic range that meets the maneuvering range of the drone to ensure accurate attitude measurement under high dynamic conditions. The scanning optical angle range of the MEMS two-dimensional galvanometer, such as horizontal ±15 °, vertical ±10 °, and the bandwidth is hundreds of hertz, which can support the forward sector scanning imaging of the small UAV platform.

The FPGA main control module uses high-speed devices, and its internal clock synchronization accuracy can reach the nanosecond level, and integrates a high-speed ADC/DAC interface for sensor control, data acquisition, and storage. Through the above device configuration and parameter selection, the system can still ensure the ranging accuracy (typical range accuracy can be better than a few centimeters), spatial resolution, and reliability of the single-photon LiDAR system in the environment of high-speed flight and severe vibration of the UAV.

Data flow and signal control logic: The data and synchronous signal interaction process between the modules of the system is clear and rigorous, as described above, coordinated by the FPGA. The specific signal direction is as follows: A high-precision timing generator runs inside the FPGA to generate a synchronous trigger pulse at the beginning of each cycle. On the one hand, it is output through the laser drive interface to excite the laser transmission pulse, and on the other hand, it is sent to the TDC as a reference mark for the time zero of the cycle. Subsequently, the FPGA delays the post-positioned high level to the AOM_A control terminal according to the internal timer, and maintains the continuous agreed pulse width time in the open state, so that the laser pulse passes through the AOM_A completely and immediately restores the low level to close the transmitting optical path. After the laser pulse is emitted by the circulator and the galvanometer and interacts with the target, the FPGA waits for the pre-calculated flight time delay, and the AOM_B control terminal is set to a high level to open the receiving window. If there is a dynamic change or uncertainty in the target distance, the FPGA can adaptively adjust its value according to the airborne height sensing or historical measurement data to achieve a “sliding window” dynamic gating. The SPAD detector generates an electrical signal when it receives photons during the AOM_B turn-on, and the signal is transmitted to the TDC timing module through a high-speed circuit. The TDC measures the time delay of the photon signal relative to the reference synchronization pulse, and feeds this time data back to the FPGA through a high-speed serial interface. The FPGA registers and matches the time data measured each time with the current galvanometer scanning angle and IMU attitude data according to the time label (as shown in the data registration module in FIG. 4) to form complete measurement information of the photon event. Meanwhile, the original measurement data of the IMU is continuously uploaded through the FPGA internal bus, and the cache is stored in a fixed cycle for subsequent pre-integration operations.

Optional technical scheme or variant embodiment: The above content, combined with the attached figures, describes the main embodiment of the present disclosure, but the present disclosure is not limited to this. In other variants, each module device can be equivalently replaced or functionally expanded according to application requirements. For example, acousto-optic modulators A and B can be replaced by high-speed electro-optic modulators or optical fiber switching devices, as long as nanosecond-level optical path switching functions can be achieved; the single-photon detector is not limited to a single APD device, and a multi-pixel SPAD array can also be used to form an array receiving, thereby improving the spatial coverage (at this time, the scanning mechanism can be appropriately simplified). The scanning galvanometer assembly can be replaced with other scanning methods, such as rotating polyhedral mirrors or MEMS phased arrays, to adapt to different platform volume and power consumption requirements. For another example, in the motion compensation algorithm, different implementation methods can be selected according to the real-time requirements: for offline data processing, the global optimization of the factor graph can be used to obtain the highest accuracy trajectory and point cloud correction results; for real-time applications, a tightly coupled solution based on Kalman filter can be used to correct the position of each laser point using IMU increment immediately when it is generated, thereby reducing the calculation delay. Furthermore, the system can only rely on IMU and laser point cloud features for matching localization (SLAM), which belongs to the extended application of the technical scheme of the present disclosure. In short, the technical personnel in this field can replace and improve the system components and method steps without deviating from the original idea of the present disclosure, which should be regarded as falling within the protection scope of the present disclosure.

What is claimed is:

1. An airborne high-precision imaging system for single-photon unmanned aerial vehicles, comprising a main control unit, a jitter acquisition unit, a signal acquisition and transmission unit, a two-dimensional scanning unit, and a motion compensation unit;
where the main control unit is electrically connected with the jitter acquisition unit, the signal acquisition and transmission unit, the two-dimensional scanning unit, and the motion compensation unit, respectively, configured to provide a picosecond global timing synchronization signal;
the jitter acquisition unit is connected with the motion compensation unit in a manner of communication, configured to transmit IMU data of the inertial navigation unit to the motion compensation unit in real time;
the signal acquisition and transmission unit is connected with the two-dimensional scanning unit in a manner of an optical path, configured to emit a laser pulse to a target area through the two-dimensional scanning unit;
the signal acquisition and transmission unit is connected with the motion compensation unit in a manner of data, configured to transmit a timestamp of a photon event to the motion compensation unit;
the motion compensation unit is configured to align the IMU data of the inertial navigation unit with a timestamp of a photon event, calculate an instantaneous attitude of each photon event, and perform a point-by-point correction on a spatial position of a photon event to eliminate a point cloud motion distortion;
the signal acquisition and transmission unit comprises a pulse laser, a single-photon detector SPAD, an acousto-optic modulator AOM1, an acousto-optic modulator AOM2 and a time-to-digital converter TDC; the acousto-optic modulator AOM1 is set in a transmitting optical path, and the acousto-optic modulator AOM2 is set in a receiving optical path; the time-to-digital converter TDC is electrically connected to the single-photon detector SPAD and the main control unit, respectively, to record timestamps of laser transmission and echo photon reception; the main control unit sets the acousto-optic modulator AOM1 to the transmitting optical path, and an opening and closing timing of the acousto-optic modulator AOM2 is precisely controlled at a nanosecond level, so that a width of the receiving window only covers an extremely narrow period near an expected signal arrival time; according to an approximate distance between the unmanned aerial vehicle and a target, a delay and a width of a receiving window are adjusted in real time to ensure that real signal photons fall when the detector is operating and most of the noise photons are rejected due to asynchrony, so that a transmitting window and the receiving window are strictly separated in time to suppress internal leakage light and near-field scattered light; and
the jitter acquisition unit comprises an inertial navigation unit IMU, and its sampling frequency is higher than a laser pulse frequency through a compensation algorithm; data of a pitch angle, a roll angle and a yaw angle of the unmanned aerial vehicle are collected in real time with high time resolution; wherein the compensation algorithm is as follows: first, the timestamp of IMU data is mapped to a time reference of FPGA to ensure that IMU time is aligned with the FPGA time; then, in each time window, a angular velocity and an acceleration of IMU are integrated to calculate increments of attitude, velocity and position; when each photon event or FPGA timestamp arrives, the calculated incremental value is used to update a state, and a frequency of the IMU is increased to nanoseconds.

2. The system according to claim 1, wherein a MEMS micromirror of the two-dimensional scanning unit swings at high speed along horizontal and vertical degrees of freedom to generate a preset scanning pattern; a deflection angle of the mirror and a timestamp of a laser transmission/reception event are used together for spatial coordinate calculation.

3. The system according to claim 1, wherein the motion compensation unit matches an inertial navigation unit IMU coordinate system, a LiDAR coordinate system and an earth fixed coordinate system, and uses a delay calibration to estimate an attitude increment between the two instants of transmitting and receiving, inertial navigation unit IMU data and the photon event data are fused as factors, and the pixel, intensity and depth correction are completed point by point for each photon event through a joint optimization of a pixel geometric constraint and a motion compensation constraint.

4. The system according to claim 1, wherein the main control unit implements picosecond global timing based on FPGA parallel and configurable logic, synchronously distributes trigger/gating/sampling control signals to the laser, acousto-optic modulator AOM, time-to-digital converter TDC, and IMU, and adds a time label of a unified time reference to time-of-flight measurements returned by TDC.

5. The system according to claim 1, wherein the motion compensation unit further performs point cloud filtering and alignment after completing single-photon event-level motion distortion correction, and maps a point-by-point corrected three-dimensional point cloud to the earth fixed coordinate system to obtain aligned three-dimensional scene data.

6. The system according to claim 1, wherein the motion compensation unit also comprises a point cloud denoising and reconstruction module based on deep learning; the module uses a convolutional neural network and integrates residual learning, batch normalization, and attention mechanisms to denoise a corrected point cloud and reconstruct a sparse point cloud into a continuous geometric surface model.

7. The system according to claim 2, wherein the acousto-optic modulator may be replaced by a high-speed electro-optic modulator or a fiber optic switching device capable of realizing a nanosecond optical path switch.

8. The system according to claim 1, wherein the two-dimensional scanning unit may be replaced by a rotating polyhedral mirror scanning mechanism or a MEMS phased array.

9. An airborne high-precision imaging method for single-photon unmanned aerial vehicles, the method is an imaging method of the system according to claim 1, wherein it comprises the following steps:
step 1, using an FPGA synchronization signal of the main control unit as a global clock to synchronize the pulse laser, the time-to-digital converter TDC, a two-dimensional galvanometer, and a high-frequency IMU;
step 2, triggering the pulse laser to emit ultrashort pulses, and starts a TDC timing by the main control unit to record a timestamp of a transmitting photon event;
step 3, closing the receiving optical path with nanosecond gating within a predetermined dead time by the main control unit, and opening the receiving optical path within a time window of an expected echo photon arrival to achieve dynamic light leakage suppression;
step 4, gating echo photons into a single-photon detector SPAD to trigger TDC to stop timing and recording a timestamp of a receiving photon event;
step 5, collecting attitude data and aligning it with the photon transmission/reception timestamp by a high-frequency IMU, combined with a system-calibrated transmitting optical path and a receiving optical path delay, obtaining a three-axis instantaneous attitude corresponding to each photon event;
step 6, using a single-photon event-level jitter compensation algorithm to calibrate a flight time and a spatial position of each photon event with high precision and eliminate a point cloud motion distortion;
step 7, performing a denoising and sparse point cloud reconstruction on the point cloud compensated by motion, and outputting a stable and clear three-dimensional scene.

10. The method according to claim 9, wherein in step 3, the dead time is in an order of nanoseconds, and the main control unit performs time-sharing gating on the transmitting optical path and the receiving optical path respectively, so that the transmitting optical path and the receiving optical path are strictly separated in time in a single ranging cycle and adaptively match an echo arrival window.

11. The method according to claim 9, wherein in step 5, the IMU attitude data is aligned with the timestamp of the photon event under a unified time benchmark, and the precise matching of each photon event attitude with its timestamp is realized by a delay calibration of the transmitting/receiving optical path.

12. The method according to claim 9, wherein in step 6, a joint optimization of IMU pre-integration and motion compensation is adopted, which solves constraints of the instantaneous attitude of transmitting and receiving, and completes a pixel geometry and depth correction point by point for each photon event.

13. The method according to claim 9, wherein in step 7, the denoising uses a convolutional neural network that integrates residual learning, batch normalization, and attention mechanisms, and the reconstruction converts a denoised point cloud into a continuous geometric surface model through a deep learning algorithm.
